(19) United States
(12) Patent Application Publication
(10) Pub. No.: US 2026/0356023 A1
(43) Pub. Date: Nov. 12, 2026

(54) METHOD FOR MANUFACTURING POLYMER FILMS

(71) Applicant: Ares Materials Inc., Plano, TX (US)

(72) Inventors: David Arreaga, Garland, TX (US); Adrian Avendano-Bolivar, Prosper, TX (US); Yoshitomo Oshima, Tokyo (JP)

(21) Appl. No.: 19/672,627

(22) Filed: May 9, 2026

Related U.S. Application Data
(60) Provisional application No. 63/803,065, filed on May 9, 2025.

(30) Foreign Application Priority Data
May 7, 2026 (JP) 2026-077908
May 7, 2026 (KR) 10-2026-0082278

(51) Int. Cl. B29C 48/08; B29C 48/355; B29L 7/00; B29L 11/00; B29L 31/34

(52) U.S. Cl. CPC B29C 48/08; B29C 48/355; B29L 2007/008; B29L 2011/00; B29L 2031/34

(57) ABSTRACT

A method for manufacturing a polymer film includes depositing a polymer resin onto a moving deposition surface of a deposition apparatus using an extrusion head, where the polymer resin is a UV-curable resin and further where the polymer resin forms a continuous film on the deposition surface. Once the polymer resin is deposited, the resin is exposed to UV light generated by a UV lamp positioned proximal to the deposition apparatus, where the polymer resin is cured by the UV light at room temperature to form a cured film. The cured film is then separated from the deposition surface using a separator tool. The cured film is then collected for additional processing. A system for manufacturing a polymer film is also disclosed. The polymer resin is applicable to fields of use such as protective coatings, flexible electronics, and general industrial uses.

### CROSS-REFERENCE TO RELATED APPLICATIONS

This application claims priority to United States Provisional Patent Application No. 63/803,065, filed May 9, 2025, and entitled “METHOD FOR MANUFACTURING POLYMER FILMS,” Japanese Patent Application No. 2026-077908, filed May 7, 2026, and entitled “METHOD FOR MANUFACTURING POLYMER FILMS,” and Korean Patent Application No. 10-2026-0082278, filed May 7, 2026, and entitled “METHOD FOR MANUFACTURING POLYMER FILMS,” the entire disclosures of which are incorporated herein by reference for all purposes.

### BACKGROUND

Film manufacturing has traditionally relied on techniques that form films out of materials such as Triacetyl Cellulose (TAC), Polyethylene Terephthalate (PET), and Ultra-Thin Glass (UTG). These techniques involve multi-stage processes, solvents, and high-temperature curing, which consume significant energy and generate substantial chemical waste. The process of manufacturing films is critical in various industries including optics, electronics, and general industrial applications. The development of new, more efficient, and environmentally friendly methods for film manufacturing is a significant area of interest.

Existing technologies for film manufacturing primarily involves multi-stage processes that require solvents and high-temperature curing. For instance, TAC films are made by dissolving cellulose acetate in an organic solvent, casting the solution onto a substrate, and then drying and curing the film at high temperatures. Similarly, PET films are produced by extruding molten polyethylene terephthalate through a slot die, followed by cooling and stretching the film to improve its mechanical properties. UTG (Ultra-Thin Glass) films are primarily manufactured using the overflow fusion process (fusion method). This process involves overflowing a trough with molten glass and allowing the molten glass to flow down both sides of a forming wedge as streams, where the two streams merge at the bottom to form a single continuous thin sheet. A key advantage of this method is that the glass's outer surfaces do not come into contact with forming equipment during the process, resulting in an exceptionally smooth, high-quality surface with minimal defects, without the need for additional polishing.

A common exemplary polymer utilized in the formation of films is PET, or polyethylene terephthalate. PET films are manufactured through processes that combine polymer processing with energy-intensive steps, particularly in heating and mechanical operations. The production methods and energy considerations generally vary by technique. A first technique that is the most common industrial method for producing BOPET (or biaxially oriented polyethylene terephthalate) is extrusion and stretching. An exemplary set of steps for performing the extrusion and stretching technique is found in Chinese Patent Publication CN104476774A (presented hereafter). In a first step, PET resin is dried in vacuum drums (0.3–0.5 MPa steam pressure, 98–102 kPa vacuum, 8–12 hours) to reduce moisture below 0.005%, which prevents oxidation during melting. In an additional step, the dried resin is melted in extruders at 240-285°C, filtered, and cast into sheets via a quenching roller cooled to 18–25°C. In an additional step, the sheets are stretched longitudinally 3.2-3.4x at 50-85°C and transversely at 3-4x at 80-110°C. Heat is subsequently applied to the stretched sheets (180-220°C for 15-25 seconds) to stabilize the film.

A second technique used to produce PET films is coating. The coating process is generally simpler than the extrusion and stretching technique above and includes coating liquid polymer onto a substrate and solidifying the coated liquid polymer. This technique requires less energy but produces lower mechanical properties. A third technique used to produce PET films is lamination. In order to carry out the lamination technique, multiple PET layers or materials are bonded using adhesives; heat and pressure are required to create a hydrolysis reaction and UV resistance. In regard to energy consumption, PET film production is generally energy intensive, where, as an example, the total energy use may range between 109.2-115.2MJ/kg (primary energy) for virgin PET polymer being processed into packaging. In regard to comparative efficiency, in general, Life Cycle Assessment (LCA) data indicates that the primary energy consumption per kilogram is approximately 20-30 MJ/kg for steel, 80-110 MJ/kg for plastic (PET), and 200 MJ/kg or more for aluminum. Additionally, recycling PET reduces energy demand by leveraging stored energy from the polymer’s production phase. This energy profile highlights opportunities for efficiency gains in para-xylene processing and renewable integration during polymerization.

Another material that is not necessarily a polymer that may be used to produce films is glass. Glass, when processed, may produce a film known as “ultra-thin glass.” Ultra-thin glass is produced using various advanced techniques (the techniques used depend on the desired properties and applications). A first technique used to produce ultra-thin glass is the slot downdraw process. An exemplary set of steps for performing the slot drawdown process is found in United States Patent US8443629B2 (presented hereafter). In a first step, a preform of glass is heated in an electric furnace to around its softening point (approximately 1,000°C). In an additional step, the softened glass is drawn through a slot, where it is thinned to the desired thickness. In an additional step, drawing rolls are used to pull the glass substrate, ensuring uniform thickness. Protective PET films may be applied in a subsequent step after the glass has cooled down in order to prevent damage during handling. In an additional step, the final ultra-thin glass is wound onto rolls for further processing or use. This technique/methodology may produce glass as thin as 20µm.

A second technique used to produce ultra-thin glass is the chemical thinning process. An exemplary set of steps for performing the chemical thinning process is found in Chinese Patent Publication CN115745416A (presented hereafter). In a first step, pre-cut glass sheets undergo groove cutting along their edges to facilitate thinning. In an additional step, the glass is chemically thinned using acid sprays (for example, hydrofluoric acid) at controlled flow rates and angles. In an additional step, after thinning, the edges of the glass are polished for strength, followed by chemical toughening and cleaning steps. This technique/methodology may provide precise thickness control and improved mechanical properties.

A third technique used to produce ultra-thin glass is the overflow fusion process. In a first step, molten glass overflows from a trough and flows down both sides of a forming blade, creating a uniform sheet. In an additional step, the glass sheets are cooled and solidified to achieve ultra-thin dimensions while maintaining high optical quality. This technique/methodology may be utilized for applications requiring exceptional surface smoothness.

Despite their widespread use, these traditional film manufacturing techniques have several limitations. Generally, these techniques are energy-intensive, requiring significant amounts of energy for solvent evaporation, drying, and high-temperature curing. This not only increases the cost of manufacturing but also contributes to carbon emissions. Additionally, these techniques generate substantial chemical waste, which poses environmental challenges. Furthermore, the multi-stage processes involved in these techniques can lead to poor film quality and thickness variations, affecting the final product's performance. Therefore, a need exists for more efficient, environmentally friendly, and scalable solutions for film manufacturing.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1A is an illustration of a side view of a belt-based manufacturing system for manufacturing a polymer film in accordance with certain embodiments of the present disclosure;

FIG. 1B is an illustration of a side view of a drum-based manufacturing system for manufacturing a polymer film in accordance with certain embodiments of the present disclosure;

FIG. 2 is an illustration of a diagram comparing the viscosity and temperature of a polymer resin in accordance with certain embodiments of the present disclosure;

FIG. 3 is an illustration of a method for manufacturing a polymer film in accordance with certain embodiments of the present disclosure;

FIG. 4 is an illustration of a cross-sectional view of an optical laminate in accordance with certain embodiments of the present disclosure; and

FIG. 5 is an illustration of a cross-sectional view of a flexible display in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates generally to polymer films, and more particularly to methods of manufacturing polymer films. In regard to the present disclosure, the term “adhesive” can include both permanent adhesives and pressure-sensitive adhesives (tacky adhesives).

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is a system for manufacturing a polymer film. The system includes an extrusion head configured to deposit a polymer resin onto a deposition surface, where the polymer resin is a UV-curable resin. A deposition apparatus includes the deposition surface, where the deposition apparatus is configured to move the deposition surface such that the polymer resin deposited thereon forms a continuous film. A UV lamp is positioned adjacent to the deposition surface and is configured to expose the polymer resin deposited on the deposition surface to UV light, where the polymer resin is cured by the UV light at room temperature to form a cured film. A separator tool is configured to separate the cured film from the deposition surface.

Additionally presented herein is a method for manufacturing a polymer film. The method includes depositing a polymer resin onto a moving deposition surface of a deposition apparatus using an extrusion head, where the polymer resin is a UV-curable resin and further where the polymer resin forms a continuous film on the deposition surface. Once the polymer resin is deposited on the deposition surface, the resin is exposed to UV light generated by a UV lamp positioned proximal to the deposition apparatus, where the polymer resin is cured by the UV light at room temperature to form a cured film. After the polymer resin is cured, the cured film is separated from the deposition surface using a separator tool. Subsequently, the cured film is collected for additional processing. The polymer resin composition can be particularly suitable as laminating films, tapes, or encapsulants for adhering to display electronic devices such as LCDs, OLEDs, flexible and foldable displays, and touch screens. The polymer resin composition is additionally applicable to fields of use such as protective coatings, flexible electronics, and general industrial uses.

According to one or more embodiments of the present disclosure, methods for manufacturing a polymer film are provided that, in comparison to traditional film manufacturing, consume less energy/electricity. It is noted that traditional film manufacturing techniques require significant amounts of energy for solvent evaporation, drying, and high-temperature curing. This not only increases the cost of manufacturing but also contributes to carbon emissions. Embodiments of the disclosed direct casting methods eliminate the need for solvents as well as high-temperature curing by utilizing room temperature UV curing techniques, resulting in a manufacturing technique that is cost-effective and environmentally friendly and that reduces energy consumption and creates a lower carbon footprint.

According to one or more embodiments of the present disclosure, methods for manufacturing a polymer film are provided that, in comparison to traditional film manufacturing, reduce chemical waste. It is noted that the multi-stage processes involved in traditional film manufacturing techniques generate substantial chemical waste, which poses numerous environmental challenges. Embodiments of the disclosed direct casting methods eliminate the need for solvents, thereby reducing chemical waste, simplifying handling, and lowering the environmental impact associated with traditional film manufacturing techniques that rely on solvents.

According to one or more embodiments of the present disclosure, methods for manufacturing a polymer film are provided that, in comparison to traditional film manufacturing, increase film quality and reduces thickness variations. It is noted that the multi-stage processes involved in traditional film manufacturing techniques can lead to film quality and thickness variations, affecting a final product's performance. Embodiments of the disclosed direct casting methods include a continuous casting and curing process that produces a film with uniform thickness and low shrinkage, thus delivering high-quality films with precise properties.

According to one or more embodiments of the present disclosure, methods for manufacturing a polymer film are provided that, in comparison to traditional film manufacturing, embody increased scalability properties. It is noted that traditional film manufacturing techniques may not be suitable for large-scale industrial use due to their complex multi-stage processes that are time-consuming and are less suitable for mass production. Embodiments of the disclosed direct casting methods support continuous, high-throughput production, thus making it adaptable for large-scale industrial use.

According to one or more embodiments of the present disclosure, methods for manufacturing a polymer film are provided that, in comparison to traditional film manufacturing, embody reduced manufacturing complexity by eliminating the need for multi-stage processes and solvent handling. It is noted that traditional film manufacturing techniques involve multi-stage processes, which can be complex and costly. Embodiments of the disclosed direct casting methods simplify manufacturing by eliminating the need for solvents and complex multi-stage processing, thereby reducing manufacturing complexity, errors and, costs and improving overall productivity.

According to one or more embodiments of the present disclosure, methods for manufacturing a polymer film are provided that, in comparison to traditional film manufacturing, embodies versatility regarding the production of multiple types of films such as, for example, rigid, flexible, transparent, and opaque films (the film produced depends on the resin formulation and intended use). It is noted that traditional film manufacturing techniques are generally not versatile enough to be able to produce multiple types of films.

According to one or more embodiments of the present disclosure, methods for manufacturing a polymer film are provided that, in comparison to traditional film manufacturing, reduce the environmental impact of film manufacturing by eliminating the need for solvents and reducing energy consumption.

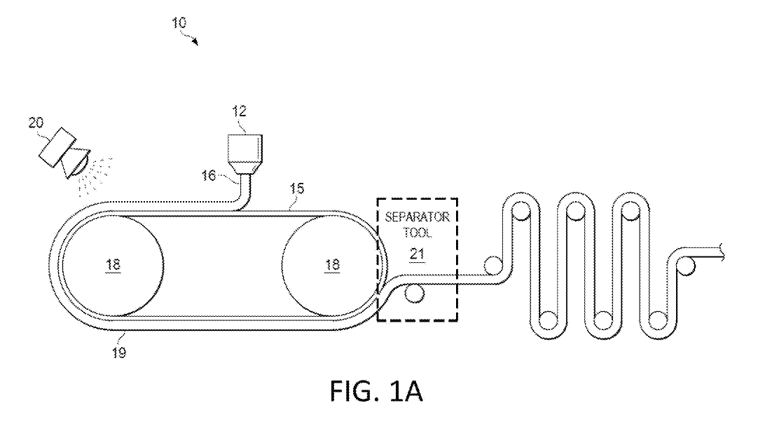

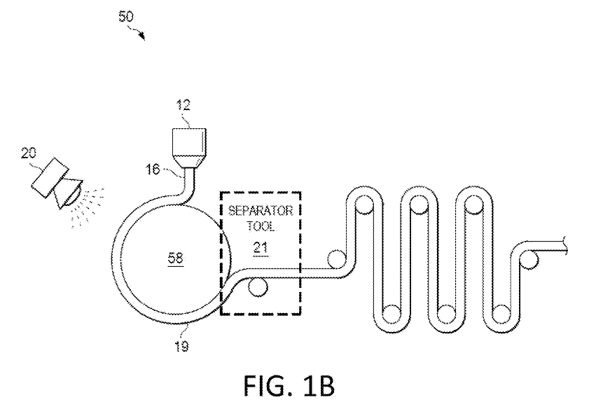

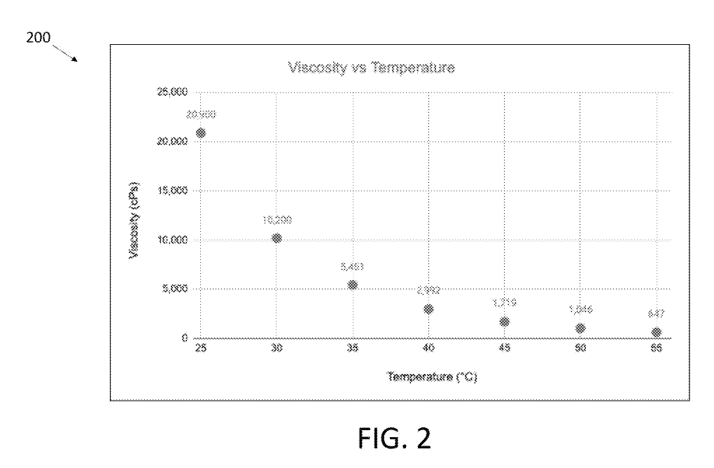

FIG. 1A is an illustration of a side view of a belt-based manufacturing system 10 for manufacturing a polymer film 19 in accordance with certain embodiments of the present disclosure. As shown, system 10 includes an extrusion head 12 positioned above a deposition surface 15 rotationally affixed to a pair of rollers 18. When in use, extrusion head 12 is configured to uniformly deposit a molten polymer resin 16 onto a deposition surface 15 (in this instance, a belt). System 10 further includes a deposition apparatus 17 (belt rotationally affixed to the pair of rollers 18) including the deposition surface 15, where deposition apparatus 17 is configured to move deposition surface 15 such that polymer resin 16 deposited thereon forms a continuous film. As film 19 travels around rollers 18, film 19 is formed with a uniform thickness and low shrinkage, ultimately forming a high-quality film embodying specific properties. In order to control the thickness of film 19, at least one of the deposition rate (of polymer resin 16) or the polymer resin viscosity may be adjusted (see FIG. 2). System 10 further includes a UV lamp 20 positioned adjacent to deposition surface 15 and configured to expose polymer resin 16 deposited on deposition surface 15 to UV light. In embodiments, UV lamp 20 is configured to emit UV light having a wavelength between 365 nm and 395 nm. In other embodiments, UV lamp 20 is configured to emit UV light having an intensity from 1 J/cm² to 7 J/cm². As polymer resin 16 is exposed to the UV light, resin 16 is cured at room temperature and forms a cured resin in the form of (cured) film 19. It is noted that the curing process is carried out using UV-curable resins, which, in embodiments, may include at least one of: a thiol-click polymer resin, an acrylate resin, and/or an epoxy resin. In embodiments, UV lamp 20 is configured to emit UV light having a wavelength between 365 nm and 395 nm. In additional embodiments, UV lamp 20 is configured to emit UV light having an intensity from 1 J/cm² to 7 J/cm².

System 10 further includes a separator tool 21 that separates cured film 19 from deposition surface 15/rollers 18. As presented in FIG. 1A, separator tool 21 is a release roller positioned adjacent one of the pair of rollers 18. Separator tool 21, in additional embodiments, may include, but is not limited to: a spatula or a wedge. Film 19 is then subsequently collected and further processed, where the additional processing may include the cutting of film 19 and/or the application of at least one additional coating to film 19 after separation from deposition surface 15. In embodiments, the at least one additional coating may include at least one of: a hard coat, an adhesive, an anti-reflective coat, and/or an anti-smudge layer (coated on top).

FIG. 1B is an illustration of a side view of a drum-based manufacturing system 50 for manufacturing a polymer film 19 in accordance with certain embodiments of the present disclosure. As shown, system 50 is substantially similar to system 10 of FIG. 1A, except that in FIG. 1B, the associated deposition apparatus 58 is a rotating drum and polymer resin 16 is deposited onto the drum. As a result of system 50 utilizing the drum, system 50 may occupy a smaller footprint within a manufacturing facility compared to system 10 (which employs a pair of rollers 18). Additionally, in embodiments, system 50 utilizing the drum may be more readily integral with continuous polymer processing techniques/methodologies. It is noted that in embodiments in which system 50 includes the drum, system 50 may occupy less area within a manufacturing plant (than if system 50 included a belt and rollers 18) while providing a similar film output (depending on parameters of system 50).

In embodiments, film 19 may be an adhesive film that may be used to adhere components and/or substrates together in/in association with a device. In other embodiments, film 19 may be a free-standing polymer film (that may be used as, for example, shock absorption). In additional embodiments, cured film 19 may comprise a thickness ranging from 20 to 200 micrometers.

FIG. 2 is an illustration of a diagram 200 comparing the viscosity and temperature of a polymer resin in accordance with certain embodiments of the present disclosure. As depicted, diagram 200 shows an inverse relationship between viscosity and temperature as the polymer resin is cured into a film. This relationship allows for increased control over the thickness of the film created during deposition. Because the viscosity dictates the flow behavior of the resin, a higher viscosity (lower temperature) generally results in a thicker film due to reduced spreading, whereas a lower viscosity (higher temperature) generally leads to a thinner film as the resin spreads more easily before curing. Within a manufacturing process, the film thickness may be controlled by adjusting the temperature of the polymer resin before deposition, thereby modifying its viscosity. Additionally, altering the extrusion rate and the curing speed may further refine the final thickness. For example, at lower temperatures (higher viscosity), the film may require higher deposition pressure or a slower belt/drum speed to maintain uniform thickness. Conversely, at higher temperatures (lower viscosity), faster processing speeds may be used while still achieving a smooth and defect-free film. By utilizing the information presented in diagram 200, film thicknesses may be optimized for different applications by tuning processing temperature, resin formulation, and deposition parameters, ensuring consistent and scalable manufacturing.

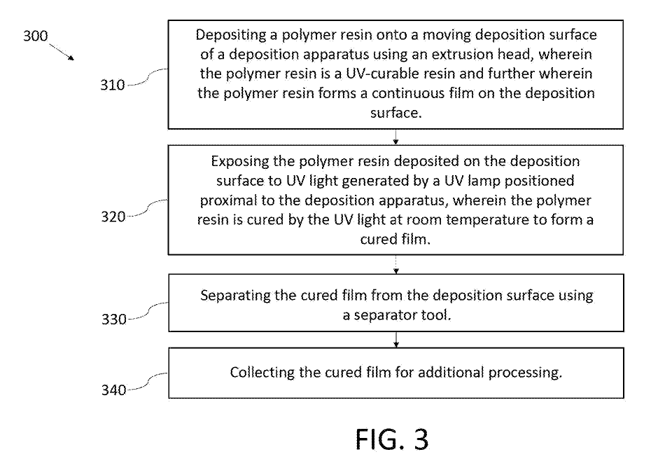

FIG. 3 is an illustration of a method 300 for manufacturing a polymer film in accordance with certain embodiments of the present disclosure. It is noted that the description of method 300 may utilize elements as similarly disclosed in the descriptions of systems 10,50 of FIGS. 1A and 1B. As presented, method 300 utilizes a direct casting process for manufacturing high-quality films. Method 300 includes depositing 310 a polymer resin 16 onto a moving deposition surface 15 of a deposition apparatus 17 using an extrusion head 12. In embodiments, deposition apparatus 17 comprises at least one of a belt rotationally affixed to a pair of roller or a rotating drum. In use, extrusion head 12 is an instrument that provides precision in relation to the manufacturing of a film. Specifically, extrusion head 12 may provide uniform distribution of polymer resin 16 on deposition surface 15. During deposition 310, in embodiments, either a drum is rotated at a speed of 3-20 rpm, or belt is driven at a corresponding linear speed (examples of deposition surfaces 15) in order to provide continuous film formation. In order to control the thickness of film 19, at least one of the deposition rate and the resin viscosity may be adjusted during the depositing 310, where the cured film comprises a thickness ranging from 20 to 200 micrometers. By controlling one or more variables in relation to the depositing 310, embodiments of method 300 may produce a film with uniform thickness and low shrinkage, leading to an end product of high-quality films with specific properties. In embodiments, polymer resin 16 utilized during the depositing 310 may be a UV curable resin, and, more specifically, may be any of: a thiol-click resin, an acrylate resin, or an epoxy resin.

Once polymer resin 16 is deposited 310, polymer resin 16 may be exposed 320 to UV light generated by a UV lamp 20 positioned proximal to deposition apparatus 17, where polymer resin 16 is cured by the UV light at room temperature to form a cured film. In embodiments, the exposing 320 may occur within one second to one minute after the depositing 310 of polymer resin 16 onto deposition surface 15. As disclosed, polymer resin 16 is exposed 320 to UV light with a 365-395 nm wavelength that is generated from a UV lamp 20 positioned above deposition surface 15. Depending on the speed at which deposition surface 15 is set, the exposure time of polymer resin 16 may vary. It is noted that the curing process may occur at room/ambient temperature, which may eliminate the need for energy-intensive heating or drying of polymer resin 16. Compared to traditional methods of polymer curing that rely on high-temperature treatments, the exposing 320 of resin 16 to UV light at room temperature reduces energy consumption, leading to an embodiment of method 300 that is more energy-efficient and cost effective than traditional polymer film processing methodologies. After polymer resin 16 is exposed 320 to UV light and cured, film 19 formed by the cured resin 16 is separated 330 from deposition surface 15. In order to more effectively separate film 19, a separator tool 21 may be utilized to gently remove film 19 from deposition surface 15. Once separated 330, cured film 19 is collected 340 for additional processing, which may include, for example, cutting cured film 19 or applying at least one additional coating to cured film 19, where the at least one additional coating comprises at least one of: a hard coat, an adhesive, an anti-reflective coat, or an anti-smudge layer. It is understood that the separating 330 provides flexibility to the film production process and additionally supports continuous, high-throughput production by enabling non-disruptive removal of the cured film 19, allowing new resin to be deposited without pausing the process. This provides a continuous workflow, which is essential for large-scale manufacturing. Additionally, the separating 330 may utilize various separator tools 21, such as, for example: release rollers, spatulas, or wedges, which may all be adjusted based on the film’s thickness, adhesion properties, and/or intended application. This adaptability allows the disclosed methods to accommodate different resin formulations and production requirements without requiring significant modifications. Furthermore, by minimizing mechanical stress on film 19 during the separating 330, the risk of defects (such as tearing, curling, or uneven thickness) is reduced, leading to higher yield rates and less material waste. These factors may contribute to a scalable and industrial-friendly film manufacturing approach, making it well-suited for high-throughput applications such as, for example: flexible displays, optical laminates, and protective coatings. In embodiments, cured film 19 may be an optically clear adhesive film having a luminous transmittance of 90% or greater at 400 nm or above.

It is further noted that the polymer resin composition can be particularly suitable as laminating films for optical laminates, tapes, adhesive layers for flexible display devices, and/or encapsulants for adhering to display electronic devices such as LCDs, OLEDs, flexible and foldable displays, and touch screens. The polymer resin composition is additionally applicable to fields of use such as protective coatings for electronic devices, flexible electronics, and general industrial uses.

In an embodiment, UV-curable resins (such as, for example: thiol-ene resins, acrylate resins, and epoxy resins) may be exposed 320 to UV light with a 365-395 nm wavelength. In an additional embodiment, UV light with a 365-375 nm wavelength may be utilized to deep cure epoxy and thiol-ene resins (utilized for higher penetration). In an additional embodiment, UV light with a 375-385 nm wavelength may be utilized with acrylates (which typically have a high reactivity, but can be sensitive to oxygen inhibition). In an additional embodiment, UV light with a 385-395 nm wavelength may be utilized to cure acrylates and hybrid systems and to increase their surface hardness. In an additional embodiment, polymers may include photoinitiators as additives, which may alter the curability of the polymers.

As disclosed, method 300 includes a direct casting process that is not reliant on solvents and complex multi-stage processing, leading to the following benefits: simplified manufacturing, simplified handling, reduced chemical waste, reduced environmental impact, and the providing of a scalable solution for producing high-quality films, such as transparent, opaque, flexible, and rigid films. These benefits make the overall polymer processing method 300 more environmentally friendly and sustainable than traditional polymer processing methods. Depending on the formulation of polymer resin 16 and/or intended use of polymer resin 16, film 19 can be tailored for any of: optical clarity, mechanical robustness, or flexibility. As a result, method 300 is configured as a versatile methodology/solution for a wide range of industries that include optical films, protective coatings, flexible electronics, and general industrial use.

In an embodiment of method 300, method 300 is carried out in a controlled environment in order to produce a high quality of film 19. In additional embodiments, a room temperature at which film 19 is manufactured may be maintained between 20-25° C. , and the relative humidity may be maintained between 40-60%. Overall, method 300 may be scalable and may be additionally adapted for large-scale industrial use. As a result of method 300, a film may be produced that may be high quality and may comprise a uniform thickness and low shrinkage. In use, film 19 may be utilized for various applications, such as for optical films, protective coatings, flexible electronics, and general industrial uses.

In embodiments, the UV curing of polymer resin 16 may occur immediately after resin 16 is deposited onto deposition surface 15. For the purposes of this disclosure, the term “immediately”, in the context of UV curing, may refer to the start of UV curing occurring between one second and one minute after deposition of polymer resin 16 (when the surface of polymer resin 16 has flattened). In additional embodiments, the UV curing step may be carried out for between one second and one minute. In additional embodiments, the UV curing step may be carried out in less than one second.

In an embodiment, separator tool 21 used to separate film 19 from deposition surface 15 may be one of: a release roller, a spatula, or a wedge. Depending on the type of polymer film being manufactured, particularly in relation to film adhesion strength, flexibility, and mechanical properties, certain separator tools 21 may offer distinct advantages. A release roller may be utilized in relation to flexible films (such as optical adhesives or encapsulants), as the release roller provides a smooth, controlled detachment of the film without introducing stress that could cause warping or defects. A spatula may be utilized in relation to rigid or highly crosslinked films, as it provides a gentle but firm separation, which may reduce the risk of cracks or breakage during detachment. For sticky or highly adhesive films, a wedge may be utilized due to the creation of a localized separation point that allows for precise peeling without excessive stretching or deformation. By selecting the appropriate separator tool 21, manufacturers may improve optimization of film detachment efficiency, reduce waste and defects, and improve scalability for industrial applications, providing adaptability to the process for different polymer formulations and production requirements.

It is noted that the direct casting process embodied in method 300 may be utilized in various technical fields/industries due to its advanced nature and advantages over traditional methods of manufacturing films. In regard to the field of optics, method 300 may revolutionize the production of optical films. High-quality optical films are salient components in various optical devices such as, for example, lenses, displays, and windows.

The ability to produce films (such as, for example, film 19) using a solvent-free, energy-efficient, and scalable process may significantly reduce manufacturing costs and environmental impact, while also improving the performance and durability of optical devices. In the electronics industry, the disclosed systems and methods may be used to manufacture protective coatings for electronic devices. These coatings may embody the characteristics of: thin, flexible, and highly durable in order to protect sensitive components from environmental hazards such as moisture, dust, and scratches. The direct casting process can produce such coatings with precise thickness and uniform quality, providing optimal protection for electronic devices. In the field of flexible electronics, the disclosed methods and systems may be used to manufacture flexible films for various applications, such as wearable devices, flexible displays, and electronic paper. The ability to produce flexible films with high optical clarity and mechanical robustness can enable the development of new and innovative flexible electronic devices. In addition to these specific fields, the direct casting process can also be used in various other industries for general industrial use. The ability to produce high-quality films with customizable properties can meet the diverse needs of different industries, from automotive to aerospace. The market demand for the aforementioned technology is expected to be high, given the increasing awareness of environmental issues and the constant quest for cost reduction in manufacturing processes. The direct casting process may meet these demands by providing a more efficient, environmentally friendly, and scalable solution for film manufacturing. Overall, embodiments of a direct casting process for film manufacturing using UV curing at room temperature has promising application prospects in various fields and may be well-positioned to meet the growing market demand for more efficient and environmentally friendly manufacturing processes.

For flexible display technology applications, in embodiments, polymer resin 16 may be cured into an adhesive film, where polymer resin 16 is cured into the film using UV light having an intensity from 1 J/cm² to 7 J/cm² at a temperature between 20-25º C. In certain embodiments, the UV light may comprise a wavelength between 365 and 395 nm. This wavelength range may provide a maximum curing depth, which may lead to efficient curing of the adhesive film. In additional embodiments, the aforementioned parameters may change based on specific photoinitiators and monomers used in resin formulations.

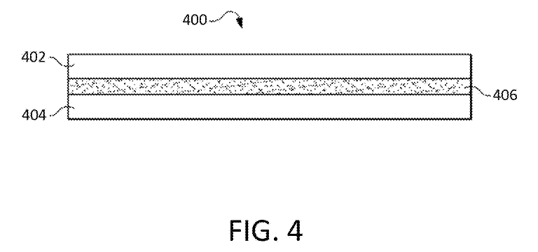

FIG. 4 is an illustration of a cross-sectional view of an optical laminate 400 in accordance with certain embodiments of the present disclosure. As shown, optical laminate 400 includes an adhesive layer 406 (in this embodiment, film 19) positioned between and in contact with a first surface of a first base layer 402 and a second surface of a second base layer 404. Adhesive layer 406 may be in direct contact with the first surface of the first base layer 402 and the second surface of the second base layer 404. In other embodiments, adhesive layer 406 may be in indirect contact with the first surface of the first base layer 402 and the second surface of the second base layer 404, where one or more additional layers (not depicted) are positioned between adhesive layer 406 and the first surface of the first base layer 402 and between adhesive layer 406 and the second surface of the second base layer 404. The additional layers may include layers such as, but not limited to, hard coat layers, primer layers, polarizing layers, light emitting layers, or color filter layers. It is further noted that adhesive layer 406 may comprise any embodiment of film 19 disclosed.

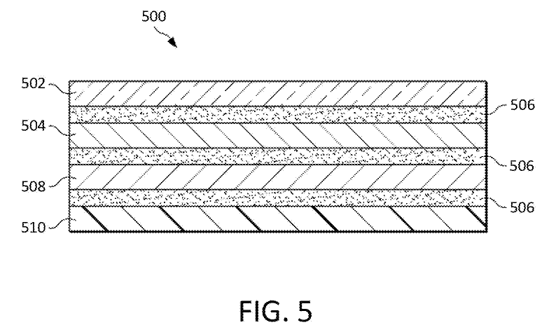

FIG. 5 is an illustration of a cross-sectional view of a flexible display 500 in accordance with certain embodiments of the present disclosure. As shown, flexible display 500 includes a plurality of layers generally associated with a flexible display and includes a window layer 502, a polarizer layer 504, a display layer 508, and a support film layer 510. An adhesive layer 506 (in this embodiment, film 19) is positioned between each pair of layers (502/504, 504/508, and 508/510). More specifically, one adhesive layer 506 of a plurality of adhesive layers 506 is positioned between and in contact with a first surface of window layer 502 and a first surface of polarizer layer 504, another adhesive layer 506 is positioned between and in contact with a second surface of polarizer layer 504 and a first surface of display layer 508, and another adhesive layer 506 is positioned between and in contact with a second surface of display layer 508 and a first surface of support film layer 510.

In other embodiments, adhesive layers 506 may be in indirect contact with the first surface of window layer 502, the first surface of polarizer layer 504, the second surface of polarizer layer 504, the first surface of display layer 508, the second surface of display layer 508, and the first surface of support film layer 510, where one or more additional layers (not depicted) are positioned between adhesive layers 506 and the first surface of window layer 502, the first surface of polarizer layer 504, the second surface of polarizer layer 504, the first surface of display layer 508, the second surface of display layer 508, and the first surface of support film layer 510. The additional layers may include layers such as, but not limited to, hard coat layers, primer layers, polarizing layers, light emitting layers, or color filter layers. It is noted that adhesive layers 506 may comprise any embodiment of film 19 disclosed. It is additionally noted that additional layers that are utilized in a flexible display and are separated by additional adhesive layers 506 can be included in the embodiment of flexible display 500, which can be recognized and understood by one skilled in the art.

One or more embodiments of this disclosure present materials for constructing higher quality and higher performing flexible display technologies in relation to other flexible display technologies.

It is noted that the polymer resin 16/film 19 presented herein may be utilized in a display/display device/display panel that may be flexible or inflexible. The polymer resin 16/film 19 may be incorporated into one or more layers of the display/display device/display panel that include, but are not limited to: a seal layer, a cathode layer, an emissive layer, an adhesive layer, a conductive layer, an anode layer, a substrate layer, and any layers mentioned in reference to FIG. 5. It is understood that the display/display device/display panel may include additional film layers that are not mentioned herein.

In an embodiment of the present disclosure, an electronic device may be provided that may utilize one or more polymer resins 16/films 19 of the present disclosure in a display/display device/display panel associated with the electronic device. For exemplary purposes, the electronic device may be any of: a smart phone, a mobile phone, a video phone, a camera, a wearable device (such as electronic clothing, an electronic accessory, a smart watch, a head-mounted apparatus, an electronic bracelet, an electronic necklace, or an electronic tattoo), a personal digital assistant (PDA), a desktop computer (PC), a laptop PC, a netbook PC, a portable multimedia player (PMP), a digital audio player, a mobile medical apparatus, an e-book reader, etc. In additional embodiments, electronic device may be a smart home appliance including a display/display device/display panel. For exemplary purposes, the smart home appliance may be any of: an electronic key, a stereo, a TV, a set-top box, a television (TV) box, a video recorder, a game console, a vacuum cleaner, a digital video disk (DVD) player, a refrigerator, an air conditioner, an oven, a dryer, an air purifier, a microwave oven, a washing machine, an electronic dictionary, an electronic photo frame, etc.

In certain embodiments, the polymer films disclosed may, in relation to optoelectronic technologies, be optically clear polymer films. In regard to these embodiments, the term “optically clear” refers to a 90% or greater transmission of light (luminous transmittance) measured for a film at 400 nm or above. It is noted that luminous transmittance can be determined in accordance with JIS K 7361 (1997). Additionally, the term “optically clear” generally refers to a state in which air bubbles cannot be visually observed. In relation to the term “optically clear”, an optically clear polymer may exhibit the property of haze, which is defined as the percentage of regular rays (of light) that are diffracted greater than 2.5 degrees from the normal (in accordance with ASTM 1003). In addition, an “optically clear” polymer may exhibit a haze value of approximately 1% or less.

In embodiments, glass may be utilized as a substrate within one or more of the disclosed methods and/or systems in order to laminate with an ultra-thin glass film. In embodiments, the ultra-thin glass film may be utilized in relation to any embodiments of the disclosed optical laminates and/or displays.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a system for manufacturing a polymer film, the system comprising: an extrusion head configured to deposit a polymer resin onto a deposition surface, wherein the polymer resin is a UV-curable resin; a deposition apparatus comprising the deposition surface, wherein the deposition apparatus is configured to move the deposition surface such that the polymer resin deposited thereon forms a continuous film; a UV lamp positioned adjacent to the deposition surface and configured to expose the polymer resin deposited on the deposition surface to UV light, wherein the polymer resin is cured by the UV light at room temperature to form a cured film; and a separator tool configured to separate the cured film from the deposition surface.

Clause 2, the system of Clause 1, wherein the deposition apparatus comprises a belt rotationally affixed to a pair of rollers.

Clause 3, the system of Clause 1, wherein the deposition apparatus comprises a rotating drum.

Clause 4, the system of Clause 1, wherein the UV-curable resin comprises at least one of: a thiol-click polymer resin, an acrylate resin, or an epoxy resin.

Clause 5, the system of Clause 1, wherein the UV lamp is configured to emit UV light having a wavelength between 365 nm and 395 nm.

Clause 6, the system of Clause 1, wherein the UV lamp is configured to emit UV light having an intensity from 1 J/cm² to 7 J/cm².

Clause 7, the system of Clause 1, wherein the separator tool comprises at least one of: a release roller, a spatula, or a wedge.

Clause 8, the system of Clause 1, wherein the cured film comprises a thickness ranging from 20 to 200 micrometers.

Clause 9, the system of Clause 1, wherein at least one of the deposition rate of the polymer resin or the polymer resin viscosity may be adjusted in order to control the thickness of the film.

Clause 10, the system of Clause 1, wherein at least one additional coating is applied to the cured film after separation from the deposition surface, the at least one additional coating comprising at least one of: a hard coat, an adhesive, an anti-reflective coat, and an anti-smudge layer.

Clause 11, a method for manufacturing a polymer film, the method comprising: depositing a polymer resin onto a moving deposition surface of a deposition apparatus using an extrusion head, wherein the polymer resin is a UV-curable resin and further wherein the polymer resin forms a continuous film on the deposition surface; exposing the polymer resin deposited on the deposition surface to UV light generated by a UV lamp positioned proximal to the deposition apparatus, wherein the polymer resin is cured by the UV light at room temperature to form a cured film; separating the cured film from the deposition surface using a separator tool; and collecting the cured film for additional processing.

Clause 12, the method of Clause 11, wherein the deposition apparatus comprises at least one of a belt rotationally affixed to a pair of rollers or a rotating drum.

Clause 13, the method of Clause 11, wherein the UV-curable resin comprises at least one of: a thiol-click resin, an acrylate resin, or an epoxy resin.

Clause 14, the method of Clause 11, wherein the UV light comprises a wavelength between 365 nm and 395 nm.

Clause 15, the method of Clause 11, wherein the depositing further comprises rotating the deposition apparatus at a speed of 3 to 20 rpm to provide continuous film formation.

Clause 16, the method of Clause 11, wherein a room temperature at which the film is manufactured is maintained between 20° C. and 25° C. , further wherein a relative humidity is maintained between 40% and 60%.

Clause 17, the method of Clause 11, wherein the exposing occurs within one second to one minute after the depositing of the polymer resin onto the deposition surface.

Clause 18, the method of Clause 11, further comprising controlling a thickness of the continuous film by adjusting at least one of a deposition rate of the polymer resin or a viscosity of the polymer resin, wherein the cured film comprises a thickness ranging from 20 to 200 micrometers.

Clause 19, the method of Clause 11, wherein the additional processing comprises at least one of cutting the cured film or applying at least one additional coating to the cured film, the at least one additional coating comprising at least one of: a hard coat, an adhesive, an anti-reflective coat, or an anti-smudge layer.

Clause 20, the method of Clause 11, wherein the cured film is an optically clear adhesive film having a luminous transmittance of 90% or greater at 400 nm or above, further wherein the cured film is configured for use as at least one of: a laminating film for an optical laminate, an adhesive layer for a flexible display device, a protective coating for an electronic device, and an encapsulant for a display device.

What is claimed is:

1. A system for manufacturing a polymer film, the system comprising:
an extrusion head configured to deposit a polymer resin onto a deposition surface, wherein the polymer resin is a UV-curable resin;
a deposition apparatus comprising the deposition surface, wherein the deposition apparatus is configured to move the deposition surface such that the polymer resin deposited thereon forms a continuous film;
a UV lamp positioned adjacent to the deposition surface and configured to expose the polymer resin deposited on the deposition surface to UV light, wherein the polymer resin is cured by the UV light at room temperature to form a cured film; and
a separator tool configured to separate the cured film from the deposition surface.

2. The system of claim 1, wherein the deposition apparatus comprises a belt rotationally affixed to a pair of rollers.

3. The system of claim 1, wherein the deposition apparatus comprises a rotating drum.

4. The system of claim 1, wherein the UV-curable resin comprises at least one of: a thiol-click polymer resin, an acrylate resin, or an epoxy resin.

5. The system of claim 1, wherein the UV lamp is configured to emit UV light having a wavelength between 365 nm and 395 nm.

6. The system of claim 1, wherein the UV lamp is configured to emit UV light having an intensity from 1 J/cm² to 7 J/cm².

7. The system of claim 1, wherein the separator tool comprises at least one of: a release roller, a spatula, or a wedge.

8. The system of claim 1, wherein the cured film comprises a thickness ranging from 20 to 200 micrometers.

9. The system of claim 1, wherein at least one of the deposition rate of the polymer resin or the polymer resin viscosity may be adjusted in order to control the thickness of the film.

10. The system of claim 1, wherein at least one additional coating is applied to the cured film after separation from the deposition surface, the at least one additional coating comprising at least one of: a hard coat, an adhesive, an anti-reflective coat, and an anti-smudge layer.

11. A method for manufacturing a polymer film, the method comprising:
depositing a polymer resin onto a moving deposition surface of a deposition apparatus using an extrusion head, wherein the polymer resin is a UV-curable resin and further wherein the polymer resin forms a continuous film on the deposition surface;
exposing the polymer resin deposited on the deposition surface to UV light generated by a UV lamp positioned proximal to the deposition apparatus, wherein the polymer resin is cured by the UV light at room temperature to form a cured film;
separating the cured film from the deposition surface using a separator tool; and
collecting the cured film for additional processing.

12. The method of claim 11, wherein the deposition apparatus comprises at least one of a belt rotationally affixed to a pair of rollers or a rotating drum.

13. The method of claim 11, wherein the UV-curable resin comprises at least one of: a thiol-click resin, an acrylate resin, or an epoxy resin.

14. The method of claim 11, wherein the UV light comprises a wavelength between 365 nm and 395 nm.

15. The method of claim 11, wherein the depositing further comprises rotating the deposition apparatus at a speed of 3 to 20 rpm to provide continuous film formation.

16. The method of claim 11, wherein a room temperature at which the film is manufactured is maintained between 20° C. and 25° C. , further wherein a relative humidity is maintained between 40% and 60%.

17. The method of claim 11, wherein the exposing occurs within one second to one minute after the depositing of the polymer resin onto the deposition surface.

18. The method of claim 11, further comprising controlling a thickness of the continuous film by adjusting at least one of a deposition rate of the polymer resin or a viscosity of the polymer resin, wherein the cured film comprises a thickness ranging from 20 to 200 micrometers.

19. The method of claim 11, wherein the additional processing comprises at least one of cutting the cured film or applying at least one additional coating to the cured film, the at least one additional coating comprising at least one of: a hard coat, an adhesive, an anti-reflective coat, or an anti-smudge layer.

20. The method of claim 11, wherein the cured film is an optically clear adhesive film having a luminous transmittance of 90% or greater at 400 nm or above, further wherein the cured film is configured for use as at least one of: a laminating film for an optical laminate, an adhesive layer
for a flexible display device, a protective coating for an electronic device, and an encapsulant for a display device.
